(19) United States
(12) Patent Application Publication
(10) Pub. No.: US 2018/0059813 A1
(43) Pub. Date: Mar. 1, 2018

(54) Virtual Reality Control Method, Apparatus, and Electronic Equipment

(71) Applicant: Beijing Xiaomi Mobile Software Co., Ltd., Beijing (CN)

(72) Inventors: Zheng LI, Beijing (CN); Xingsheng LIN, Beijing (CN); Xuanran WANG, Beijing (CN)

(73) Assignee: Beijing Xiaomi Mobile Software Co., Ltd., Beijing (CN)

(21) Appl. No.: 15/691,122

(22) Filed: Aug. 30, 2017

Related U.S. Application Data
(63) Continuation of application No. PCT/CN2016/097418, filed on Aug. 30, 2016.

(51) Int. Cl. G06F 3/0346; G06F 1/16; G06T 19/00; G06F 3/01

(52) U.S. Cl. CPC G06F 3/0346; G06F 3/011; G06T 19/003; G06F 1/163

(57) ABSTRACT

A VR control method, device, and electronic equipment are provided. The method includes: acquiring sensor data indicative of a movement of a VR wearable device in three-dimensional space within a set time period, and the set time period is determined by a first time point at which a first control instruction is received and a second time point at which a second control instruction is received; determining a moving trajectory of the VR wearable device within the set time period based on the sensor data within the set time period; and controlling a VR execution device to perform one or more operations corresponding to the moving trajectory and to display operation effects corresponding to the moving trajectory on the VR display device.

### CROSS-REFERENCE TO RELATED APPLICATION

This application is based upon and claims priority to PCT Application No. PCT/CN2016/097418, filed on Aug. 30, 2016, the entire contents thereof are incorporated herein by reference.

### TECHNICAL FIELD

The present disclosure relates to the field of virtual reality, and particularly to a virtual reality control method, apparatus and electronic equipment.

### BACKGROUND

In the related art, interactions between a virtual reality (VR) device and a mobile phone are usually controlled with handles of VR devices. For example, the user triggers the VR device by pressing buttons on the touch handle, such as, up, down, left, right, enter and so on. However, when the user is wearing the VR device, since his/her eyes have been blocked by the display of the VR device, the user can only feel the buttons by touch, without seeing them with eyes. In this situation, the user may press wrong buttons, and thus it may be very inconvenient for the users.

### SUMMARY

In order to overcome the problems in the related art, the present disclosure provides a VR control method, apparatus and electronic equipment for improving the convenience of operating the VR devices.

According to a first aspect of the present disclosure, it is provided a virtual reality (VR) control method. The method may include: acquiring sensor data indicative of a movement of a VR wearable device in three-dimensional space within a set time period. The set time period is determined by a first time point at which a first control instruction is received and a second time point at which a second control instruction is received. The method further includes determining a moving trajectory of the VR wearable device within the set time period based on the sensor data within the set time period; and controlling a VR execution device to perform one or more operations corresponding to the moving trajectory and to display operation effects corresponding to the moving trajectory on the VR display device.

According to a second aspect of the present disclosure, it is provided a virtual reality (VR) control apparatus. The VR control apparatus may include: a data acquisition circuitry, a trajectory determination circuitry, and an operation control. The data acquisition circuitry is configured to acquire sensor data within a set time period in which a VR wearable device is moved in three-dimensional space, and the set time period is determined by a first time point at which a first control instruction is received and a second time point at which a second control instruction is received. The trajectory determination circuitry is configured to determine a moving trajectory of the VR wearable device within the set time period based on the sensor data within the set time period. The operation control circuitry is configured to control a VR execution device to perform one or more operations corresponding to the moving trajectory and to display operation effects corresponding to the moving trajectory on the VR display device.

According to a third aspect of the present disclosure, it is provided an electronic equipment. The electronic equipment may include: a processor, and a memory configured to store instructions that can be executed by the processor. The processor is configured to: acquire sensor data within a set time period in which a VR wearable device is moved in three-dimensional space, and the set time period is determined by a first time point at which a first control instruction is received and a second time point at which a second control instruction is received; determine a moving trajectory of the VR wearable device within the set time period based on the sensor data within the set time period; and control a VR execution device to perform one or more operations corresponding to the moving trajectory and to display operation effects corresponding to the moving trajectory on the VR display device.

It is to be understood that the foregoing general description and the following detailed description are exemplary and explanatory only, and do not limit the scope of the present disclosure in any way.

### BRIEF DESCRIPTION OF THE DRAWINGS

The drawings herein are incorporated in and constitute a part of this specification, showing aspects of this disclosure and, together with the description, serve to explain the principles of the present disclosure.

FIG. 1A is a schematic flow chart of a VR control method according to an aspect of the disclosure.

FIG. 1B is a first exemplary scenario of a VR control method according to an exemplary embodiment.

FIG. 1C is a second exemplary scenario of a VR control method according to an aspect of the disclosure.

FIG. 2A is a schematic flow chart of a VR control method according to an aspect of the disclosure.

FIG. 2B is a flow chart of step 203 in accordance with FIG. 2A.

FIG. 3 is a schematic flow chart of a VR control method according to a second aspect of the disclosure.

FIG. 4 is a schematic flow chart of a VR control method according to a third aspect of the disclosure.

FIG. 5 is a structural diagram of a VR control apparatus according to an aspect of the disclosure.

FIG. 6 is a structural diagram of another VR control apparatus in accordance with an aspect of the disclosure.

FIG. 7 is a structural diagram of a further VR control apparatus according to an aspect of the disclosure.

FIG. 8 is a block diagram of another device that is suitable for controlling a VR device according to an aspect of the disclosure.

### DETAILED DESCRIPTION

Hereinafter, examples embodiments of disclosure are described and shown in the drawings. In the following description, when referring to the drawings, the same numerals in the different drawings denote the same or similar elements unless otherwise indicated. The aspects described in the following examples are not representative of all embodiments that comply with the principle of the present disclosure. Rather, they are merely examples of devices and methods that comply with some aspects of the present disclosure which have been described in details in the appended claims.

The technical solution provided by the present disclosure may have the following advantageous effects. The VR device may determine the moving trajectory of the VR wearable device within the set time period based on the sensor data within the set time period. The VR device may control the VR execution device to perform one or more operations corresponding to the moving trajectory and display the operation effects corresponding to the moving trajectory on the VR display device. Thus, the operations of the VR execution device may be controlled based on the body actions detected from the sensor data. It is not necessary for the user to manually press different buttons on the handle to trigger different operation. The disclosed devices and methods ensure that the VR execution device can perform the action that the user really wants, and display the moving trajectory corresponding to the operation visual effects with the VR display device, so as to improve the variety of the VR execution device input modes and facilitate interactions between the user and the VR display device.

By displaying the moving trajectory on the VR display device, the user wearing the VR wearable device can visually perceive the trajectory when he moves the VR wearable device. When the moving trajectory does not coincide with the reference trajectory, the user can adjust the direction that he moves the VR wearable device, to improve the user's experience of using the VR wearable equipment.

By sequentially rendering the sensor data within the set time period at the black dot on the VR display device, the user can visually feel like the instruction control process and the acceleration data display process fit with each other on real-time, and thereby the immersion feeling caused by the VR display device can be enhanced.

It is possible to ensure that the user can accurately control the VR execution device by prompting the user to move the VR wear device once again. By clearing the sensor data within the set time period, it is possible to prevent the electronic device or the VR execution device from storing too much redundant data and improving the storage space utilization rate.

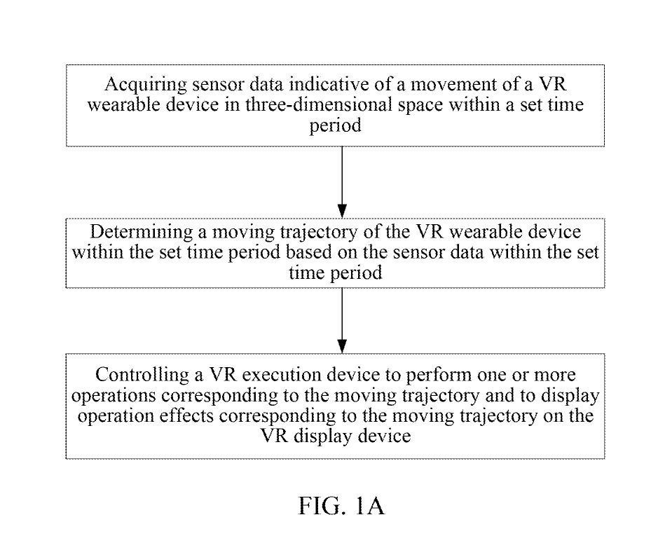

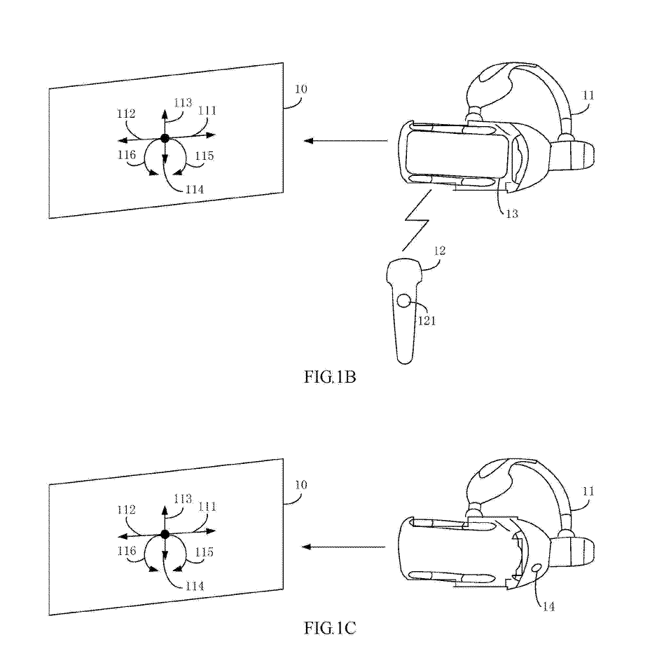

FIG. 1A is a schematic flow chart of a VR control method according to an aspect of the disclosure, FIG. 1B is a first scene diagram of a VR control method according to an aspect of the disclosure, and FIG. 1C is a second scene diagram of a VR control method according to an aspect of the disclosure. The VR control method can be applied to an electronic device (e.g., a smart phone, a tablet PC, a personal computer, a VR device, etc.). As shown in FIG. 1A, and the VR control method includes the following steps 101-103:

In step 101, sensor data indicative of a movement of a VR wearable device are acquired in three-dimensional space within a set time period. The set time period is determined by a first time point at which a first control instruction is received and a second time point at which a second control instruction is received. The set time period is defined by the first time point and the second time point, which are respectively determined by the first control instruction and the second control instruction. For example, the first time point is set when receiving a first control instruction and the second time point is set when receiving a second control instruction.

In one aspect, the sensor data may be the rotational angular acceleration collected by a gyro sensor or the three-axial acceleration data collected by an acceleration sensor. The moving trajectory of the VR wearable device can be identified from the distribution of the sensor data over the set period of time. At that time, the VR wearable device is worn by the user at the head. In one or more embodiments, the first control instruction and the second control instruction may either be triggered by pressing a button on the handle bound with the VR wearable device or may be triggered by pressing a predetermined button on the VR wearable device itself.

The method further includes, in step 102, determining a moving trajectory of the VR wearable device within the set time period based on the sensor data within the set time period.

For example, during the set time period, the user may control the VR execution device according to the instructions to move the VR execution device as needed. The user may tilt or rotate the head to the right and then to the left, raise the head upwards and lower the head, and turn the head to the right side and then to the left side, and so on, while the body remains stationary. The above movements may be identified based on the sensor data collected by the sensor.

In step S103, the method proceeds to control a VR execution device to perform one or more operations corresponding to the moving trajectory and to display operation effects corresponding to the moving trajectory on the VR display device.

In one or more embodiments, the moving trajectory and the corresponding operation may be set by the users according to their operating habits. For example, bowing the head downward or lowering the head indicates a “confirm” operation, raising head upward indicates a “return” operation, tilting or rotating the head to the right side indicates a “slide-to-the-right” operation, and tilting or rotating the head to the left indicates a “slide-to-the-left” operation and so on.

In one exemplary scenario, as shown in FIG. 1B, the VR wearable device 11 itself is provided with a sensor. The handle 12 is bound to the VR wearable device 11. The electronic equipment 13 may be clamped on the VR wearable device 11, as a VR display device which is bounded to the VR wearable device 11. Alternatively or additionally, the electronic equipment 13 may implement the method described in this disclosure as a VR execution device.

When the user is wearing the VR wearable device 11, the user can send a DownEvent trigger event (i.e., a first control instruction) to the electronic equipment 13 by triggering the button 121 on the handhold handle 12, and the button 121 sends the DownEvent trigger event to the electronic equipment 13 via Bluetooth communication if the user needs to perform the “slide-to-the-left” operation. The electronic device 13, upon receiving the DownEvent trigger event, acquires sensor data from the VR wearable device 11. When the user releases the button 121, the button 121 sends an UpEvent trigger event (i.e., a second control instruction) via the Bluetooth communication to the electronic equipment 13. The electronic equipment 13 determines a moving trajectory of the VR wearable device 11 based on the sensor data within a set time period between the time point of receiving the first control instruction and that of receiving the second control instruction. For example, as to the moving trajectory 112 as shown in FIG. 1B, the electronic equipment 13 performs a slide-to-the-left operation corresponding to the moving trajectory 112. Alternatively, the electronic device 13 may be, e.g., a personal computer, and in this situation, the VR display device may be a display screen provided with the VR wearable device 11.

In another exemplary scenario as shown in FIG. 1C, the VR wearable device 11 is provided with a sensor and a display screen. The handle 12 is bound to the VR wearable device 11. The VR wearable device 11, the VR execution device, and the VR display device are an integral structure which forms a helmet, where the VR wearable device 11 may implement the method described in this disclosure. When the user is wearing the VR wearable device 11, the user may trigger the button 14 on the VR wearable device 11 if the user needs to perform the “slide-to-the-left” operation. When there are multiple buttons on the VR wearable device 11, the button may be predetermined or set by the user during initial setup. The VR wearable device 11 detects that the predetermined button 14 is triggered (the trigger event can be regarded as the first control instruction described in the present disclosure). Accordingly, the moving trajectory of the VR wearable device 11 is recognized based on the sensor data acquired by itself. When the user releases the predetermined button 14, the VR wearable device 11 may detect a release trigger event (which may be considered as the second control instruction as described in this disclosure), and then the VR wearable device 11 can determine the moving trajectory of the VR wearable device 11 during the set time period based on the sensor data. Here, the set time period may be defined by the first and second time points, where the first time point corresponds to the time when receiving the first control instruction and the second time point corresponds to the time when receiving the second control instruction. For example, as to the trajectory 112 as shown in FIG. 1C, the VR wearable device 11 is controlled to perform the slide-to-the-left operation corresponding to the moving trajectory 112.

In the above-described FIGS. 1B and 1C, reference numeral 10 may be regarded as a display screen on the electronic device 13 used by a user or a display screen of the VR wearable device 11. In the present disclosure, for convenience of description, the box shown in reference numeral 10 is referred to as equivalent screen 10. The equivalent screen 10 is only an example provided for the purpose of explaining the content that is displayed on the display screen on the electronic device 13 or the display screen of the VR wearable device 11. During the movement of the VR wearable device 11, for example, the reference numeral 111 may represent a moving trajectory of the user whose body remains stationary and the head tilts to the right, which indicates an “slide-to-the-right” operation. The reference numeral 112 may represent a moving trajectory of the user whose body keeps stationary and the head tilts to the left, which indicates an “slide-to-the-left” operation. The reference numeral 113 may represent a moving trajectory of the user whose body remains stationary and face is raised upward, which indicates a “return” operation. The reference numeral 114 may represent a moving trajectory of the user whose head is bowed downwards, which indicates a “confirm” operation. The reference numeral 115 may represent a moving trajectory of the user whose body remains stationary and the face is turned to the right side, which indicates a operation of “turning the page to the right.” The reference numeral 116 may represent a moving trajectory of the user whose body remains stationary and the face is turned to the left to rotate the head, which indicates a operation of “turning the page to the left.” It will be appreciated by those skilled in the art that in each operation of the user, only the moving trajectory coinciding with this operation is displayed on the equivalent screen 10. The plurality of moving trajectories shown in FIGS. 1B and 1C are examples of different moving trajectories corresponding to different operations, which should not be considered as limitations to the present disclosure.

In the disclosure, by determining the moving trajectory of the VR wearable device in the set time period based on the sensor data within the set time period, controlling the VR execution device to perform an operation corresponding to the moving trajectory and displaying operation effects corresponding to the moving trajectory on the VR display device, the user can trigger different buttons on the handle to achieve different operations with body actions, so as to ensure that the VR execution device can perform the actions that the user really wants. By displaying the visual effects corresponding to the moving trajectories on the VR display device, the diversity of the input modes of the VR execution device is improved and the interaction between the user and the VR display device is facilitated.

In one or more embodiments, the step of determining a moving trajectory of the VR wearable device within the set time period based on the sensor data within the set time period may include:

determining a moving direction in which the VR wearable device moves in the three-dimensional space based on sensor data within the set time period; and

rendering the moving trajectory of the VR wearable device on the VR display device based on the sensor data within the set time period in the direction chronologically.

In one or more embodiments, the step of rendering the moving trajectory of the VR wearable device on the VR display device based on the sensor data within the set time period in the direction chronologically may include:

at the first time point, rendering a first set of sensor data among the sensor data within the set time period in a central region of the VR display device;

rendering the moving trajectory corresponding to the sensor data within the set time period chronologically along the direction; and

at the second time point, rendering the last set of sensor data among the sensor data within the set time period in the central region of the VR display device, and said rendering the moving trajectory of the VR wearable device is completed.

In one or more embodiments, the step of controlling a VR execution device to perform one or more operations corresponding to the moving trajectory may include:

determining whether there is a target trajectory matching the shape of the moving trajectory from a plurality of reference trajectories corresponding to an operation instruction for controlling the VR execution device;

determining an operation instruction corresponding to the target trajectory; and

controlling the VR execution device to perform an operation corresponding to the operation instruction.

In one or more embodiments, the method may further includes:

generating a message for prompting to move the VR wearable device if it is determined that there isn't a target trajectory from the plurality of reference trajectories; and

clearing the sensor data within the set time period.

In one or more embodiments, the sensor data indicative of a movement of a VR wearable device in three-dimensional space within a set time period may include:

acquiring the sensor data indicative of the movement indicating a movement of the VR wearable device in the three-dimensional space from a first gyro sensor of the electronic device, upon receipt of the first control instruction from the handle bounded to the VR wearable device; and

upon receipt of the second control instruction from the handle, stopping acquiring sensor data from the first gyro sensor, so as to complete the acquisition of the sensor data within the set period of time.

In one or more embodiments, the step of acquiring sensor data indicative of a movement of a VR wearable device in three-dimensional space within a set time period may include:

generating the first control instruction and determining the first time point at which the first control instruction is generated, when it is detected that a predetermined button on the VR wearable device is triggered;

acquiring the sensor data indicative of the movement of the VR wearable device in three-dimensional space which is captured by the second gyroscope of the VR wearable device according to the first control instruction;

generating the second control instruction and determining the second time point at which the second control instruction is generated, when it is detected that the predetermined button is triggered again; and

stopping acquiring the sensor data from the second gyro sensor according to the second control instruction, and completing the acquisition of the sensor data within the set time period.

The subsequent embodiments are provided to explain how to acquire the sensor data.

In the present disclosure, body actions may be detected so as to control the operation of the VR execution device. The may use the same button to trigger the VR device to receive different user inputs, which may correspond to different predefined operations. Thus, there is no need for the user to manually press different buttons on the handle to trigger different operation, which thereby ensure that the VR execution device can perform the action that the user really wants, to improve the variety of the VR execution device input modes and facilitate interactions between the user and the VR display device.

Hereinafter, the technical solution provided in the embodiments of the present disclosure will be explained in details with reference to examples.

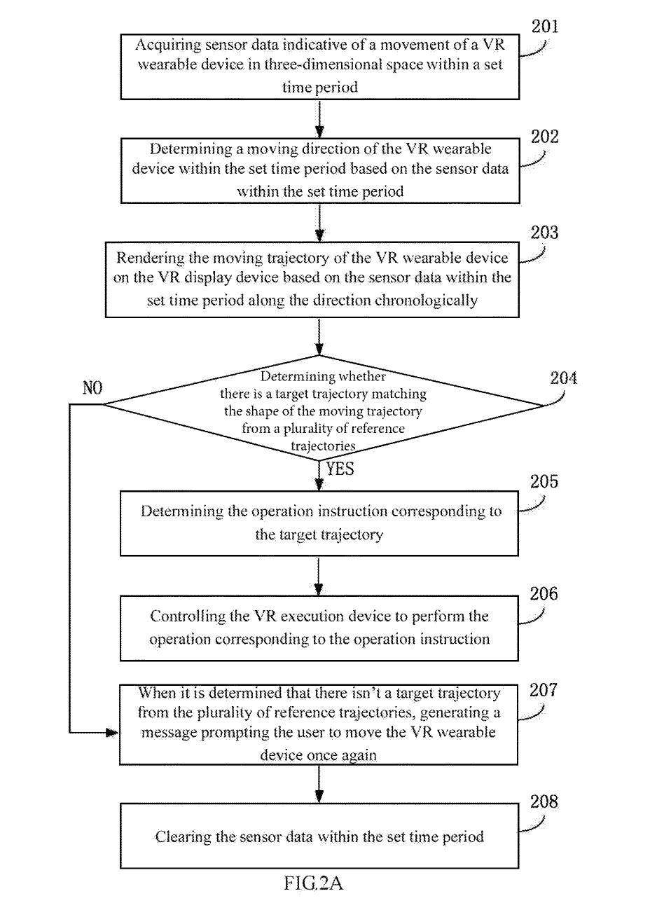

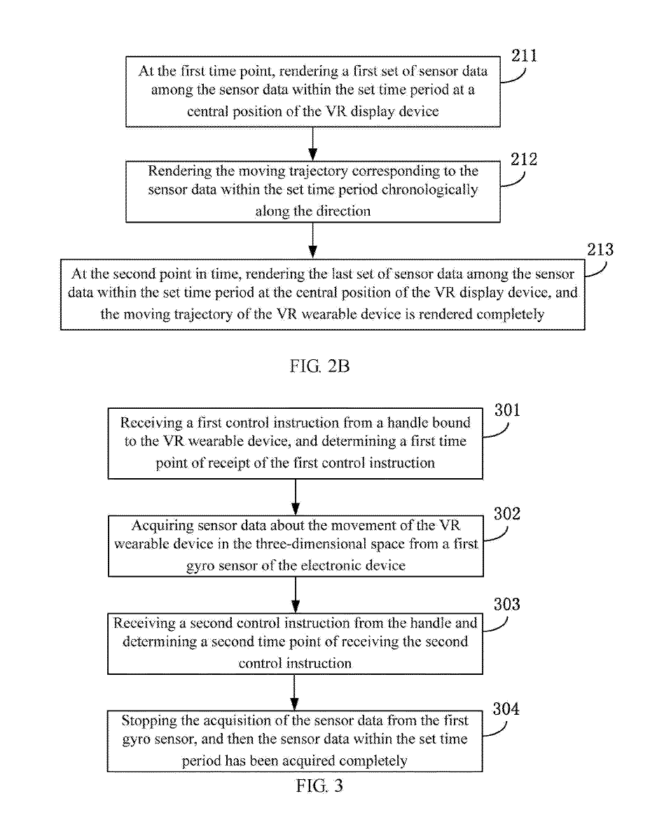

FIG. 2A is a schematic flow chart of a VR control method according to a first aspect of the disclosure. FIG. 2B is a flow chart of step 203 in accordance with the embodiment shown in FIG. 2A. In the first embodiment, the above-described method provided by the embodiments of the present disclosure will be further described. An exemplary explanation of how the moving trajectory is rendered on the VR display device will be provided as an example with reference to FIGS. 1B and 1C. As shown in FIG. 2A, the method includes:

In step 201, acquiring sensor data indicative of a movement of a VR wearable device in three-dimensional space within a set time period, and the set time period is determined by a first time point at which a first control instruction is received and a second time point at which a second control instruction is received.

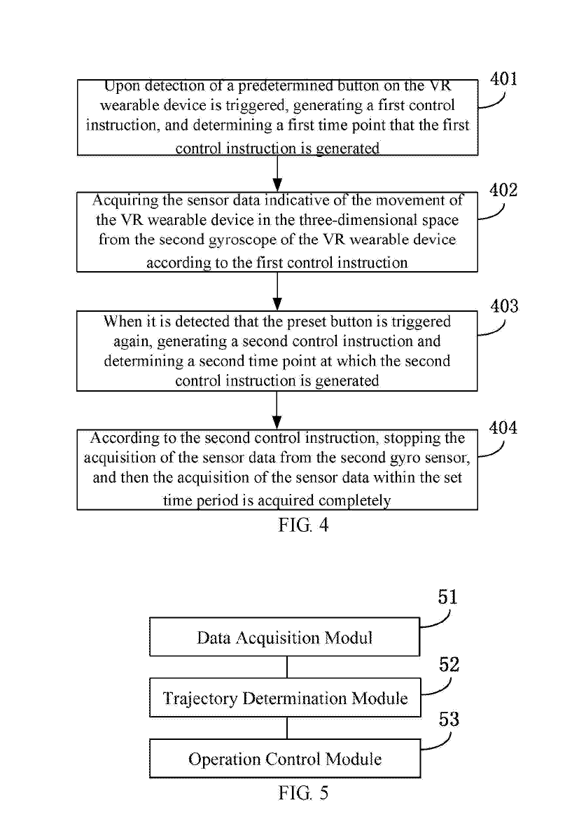

With respect to the details of step 201, please refer to the descriptions about FIG. 1A as discussed above or the descriptions about the embodiments as shown in FIG. 3 or FIG. 4 that will be provided hereinafter, and thus details of that step will be omitted here.

As step 202, a moving direction of the VR wearable device within the set time period is determined based on the sensor data within the set time period.

In one or more embodiments, descriptions will be provide with angular acceleration in six directions collected by a gyro sensor as an example of the sensor data. Here, by converting the values of the angular acceleration in the six directions into quaternion, the posture of the VR wearable device in the three-dimensional space is calculated from the quaternion. Accordingly, the moving direction of the VR wearable device in the three-dimensional space is further determined based on the posture. How to calculate the posture of the VR wearable device in the three-dimensional space from the quaternion may be referred to the description of the related art, details of which are omitted in this disclosure.

In step 203, the moving trajectory of the VR wearable device is rendered on the VR display device based on the sensor data within the set time period along the direction chronologically.

Details of step 203 may be referred to the following description as to FIG. 2B, and will be omitted here.

In step 204, it is determined whether there is a target trajectory matching the shape of the moving trajectory from a plurality of reference trajectories, where each of the plurality of the reference trajectories corresponds to an operation instruction for controlling the VR execution device, if yes, the method proceeds to step 205; and if no, the method proceeds to step 207.

In one or more embodiments, for example, a plurality of reference trajectories are displayed on the equivalent screen 10 as shown in FIGS. 1B and 1C, wherein each of the reference trajectories corresponds to a shape which may include a moving direction and a moving distance of the trajectory. Reference are made to the related art as to the descriptions about trajectories, which are omitted here.

In step 205, an operation instruction corresponding to the target trajectory is determined.

In step 206, the VR execution device is controlled to perform an operation corresponding to the operation instruction.

In one or more embodiments, for example, when a moving trajectory matches the shape of the trajectory indicated by the reference numeral 111 as shown in FIG. 1B, the VR wearable device 11 is controlled to perform the “slide-to-the-right” operation because the trajectory 111 corresponds to the “slide-to-the-right” operation control instruction. In one or more embodiments, when the electronic equipment 13 executes the disclosed method in the one or more embodiments, the electronic equipment 13 may control the VR execution device to perform a “slide-to-the-right” operation, that is, the electronic equipment 13 performs the “slide-to-the-right” operation.

In step 207, when it is determined that there isn't a target trajectory from the plurality of reference trajectories, a message prompting the user to move the VR wearable device once again will be generated.

In step 208, the sensor data within the set time period is cleared.

For example, when the posture of the user wearing the VR wearable device 11 is not standard, it is possible that the shape of the moving trajectory cannot match the shape of any one of the plurality of reference trajectories. Therefore, it is necessary to inform the user to move the VR wearable device 11 once again. In one or more embodiments, the user may be prompted to move the VR wearable device 11 once again, by displaying a text message on the equivalent screen 10. In another embodiment, the user may be informed to move the VR wearable device 11 once again by playing audio.

By prompting the user to move the VR wearable device once again, it is possible to ensure that the user can accurately control the VR wearable device. By clearing the sensor data within the set time period, it is possible to prevent the electronic equipment or the VR wearable device from storing too much useless data, so as to improve utilization rate of the storage.

As shown in FIG. 2B, step 203 may include the following steps:

In step 211, at the first time point, rendering a first set of sensor data among the sensor data within the set time period in a central region of the VR display device.

For example, if the sensor has collected 100 sets of sensor data within a set period of time, and each set of sensor data includes sensor data on each dimension, the first set of sensor data from among the 100 sets of sensor data can be rendered on the central region of the VR display device. For example, the user may visually see that the first set of sensor data is rendered at a black dot of the equivalent screen 10, where the black dot indicates the center position of the VR display device.

In step 212, the moving trajectory corresponding to the sensor data within the set time period is chronologically rendered along the direction.

In step 213, at the second time point, the last set of sensor data among the sensor data within the set time period is rendered in the central region of the VR display device, and the step of rendering the moving trajectory of the VR wearable device is completed.

In one or more embodiments, the first set of sensor data may be moved along the moving direction of the VR wearable device in sequence, sequentially displaying the second set of sensor data, the third set of sensor data at the black dot of the equivalent screen 10, until the second control instruction is received, the last set of sensor data is rendered at the black dot of the VR display device, allowing the user to visually have a feeling of real-time fit of the instruction control process and the acceleration data display process, so as to enhance the immersion caused by the VR wearable device. For example, the sensor data that coincides with the moving direction may be identified from the sensor data of the respective dimensions during the process of rendering the moving trajectory, so as to ensure that the trajectory moving on the VR display device is exactly the same as the moving direction the user.

In one or more embodiments, the sensor data within the set time period is rendered as a moving trajectory of the VR wearable device chronologically, and the moving trajectory is displayed on the VR display device, allowing the user wearing the VR wearable apparatus to be able to visually perceive the moving trajectory of the VR wearable device. When the moving trajectory cannot match the reference trajectories, users can timely adjust the direction of the VR wearable device, so as to improve the user experience of the VR wearable device.

FIG. 3 is a schematic flow chart of a VR control method according to a second aspect of the disclosure. In the second embodiment, the above-described method provided by the embodiments of the present disclosure will be further described. An exemplary explanation of how to collect sensor data from a first gyro sensor of the electronic equipment will be provided as an example with reference to FIG. 1B. As shown in FIG. 3, the method includes:

In step 301, a first control instruction is received from a handle bound to the VR wearable device, and a first time point of receipt of the first control instruction is determined.

In step 302, sensor data about the movement of the VR wearable device in the three-dimensional space is acquired, which is collected by a first gyro sensor of the electronic device.

In step 303, a second control instruction from the handle is received and a second time point of receiving the second control instruction is determined.

In step 304, the acquisition of the sensor data from the first gyro sensor is stopped, and then the acquisition of the sensor data within the set time period is completed.

In an exemplary scenario, as shown in FIG. 1B, when the user presses the button 121 on the handle 12, the handle 12 generates a first control instruction. The electronic equipment 13 receives the first control instruction via Bluetooth or other communication technology and determines the first time point at which the first control instruction is received. Since the electronic equipment 13 is mounted on the VR wearable device 11 and acts as a VR display device, the first gyro sensor on the electronic equipment 13 may collect the sensor data about the movement of the VR wearing device 11 moving in the three-dimensional space when the user wears the VR wearable device 11. When the user releases the button 121, the handle 12 generates a second control command, and the electronic equipment 13 stops receiving the sensor data from the first gyro sensor upon receipt of the second control instruction from the handle 12, and then the acquisition of the sensor data within the set time period is completed.

In one or more embodiments, the movement of the VR wearable device that is moved by the user is controlled by triggering a button on the handle. Since only one button on the handle is needed to assist in the implementation of the control of the VR execution device, the design of the handle is simplified and the hardware cost is reduced. By utilizing the first gyro sensor inherent in the electronic equipment, the hardware configuration of the VR wearable device can be simplified, and the hardware cost of the VR wearable device can be reduced.

FIG. 4 is a schematic flow chart of a VR control method according to a third aspect of the disclosure. In the third embodiment, the above-described method provided by the embodiments of the present disclosure will be further described. An exemplary explanation of how to collect sensor data from a second gyro sensor of a VR wearable device will be provided as an example with reference to FIG. 1C. As shown in FIG. 4, the method includes:

In step 401, upon detection of a predetermined button on the VR wearable device is triggered, a first control instruction is generated, and a first time point that the first control instruction is generated is determined.

In step 402, the sensor data indicative of the movement of the VR wearable device in the three-dimensional space, is collected by the second gyroscope of the VR wearable device according to the first control instruction.

In step 403, when it is detected that the predetermined button is triggered again, a second control instruction is generated and a second time point at which the second control instruction is generated is determined.

In step 404, according to the second control instruction, the acquisition of the sensor data from the second gyro sensor is stopped, and then the sensor data within the set time period is acquired completely.

In an exemplary scenario, as shown in FIG. 1C, when the user presses the predetermined button 14 on the VR wearable device 11, the VR wearable device 11 generates a first control instruction and determined a first time point at which the first control instruction is generated. In the case that the VR wearable device 11 is integrated with the VR display device and the VR wearable device 11 is equipped with a second gyro sensor, when the user wearing the VR wearable device 11 moves, the sensor data about the movement of the VR wearable device 11 in three-dimensional space can be collected by the second gyro sensor provided on the VR wearable device 11. When the user releases the predetermined button 14, the VR wearable device 11 generates a second control instruction to stop the acquisition of the sensor data from the second gyro sensor and then the acquisition of the sensor data within the set time period is completed.

In one or more embodiment, since the VR wearable device is integrated with the VR display device and the VR wearable device 11 is equipped with the second gyro sensor, it is possible to avoid excessive interaction between the VR wearable device and the electronic equipment, and thus the efficiency of control operation of the VR wearable device and operability are improved.

FIG. 5 is a structural diagram of a VR control apparatus according to an aspect of the disclosure. As shown in FIG. 5, the VR control apparatus includes:

a data acquisition module 51, configured to acquire sensor data within a set time period in which a VR wearable device is moved in three-dimensional space, and the set time period is determined by a first time point at which a first control instruction is received and a second time point at which a second control instruction is received;

a trajectory determination module 52, configured to determine a moving trajectory of the VR wearable device within the set time period based on the sensor data within the set time period; and

an operation control module 53, configured to control a VR execution device to perform one or more operations corresponding to the moving trajectory and to display operation effects corresponding to the moving trajectory on the VR display device.

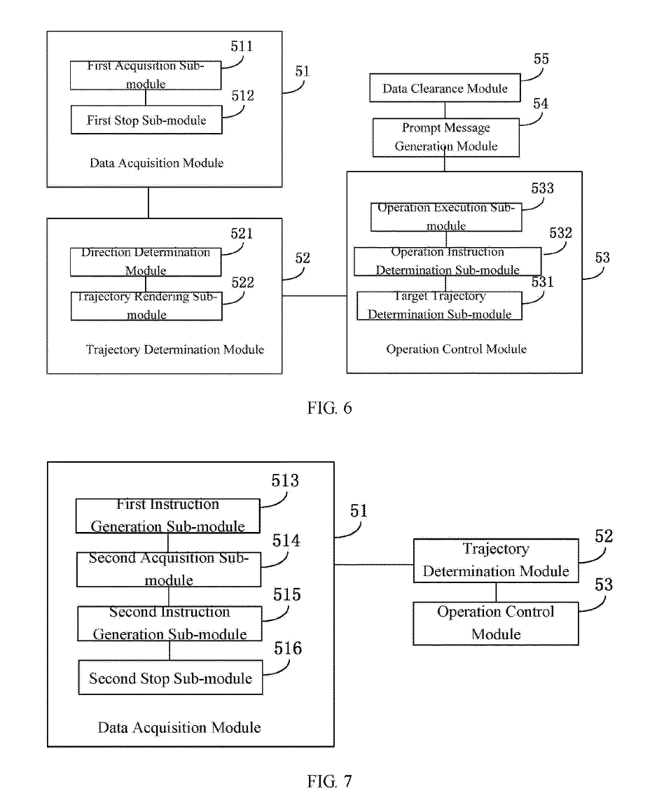

FIG. 6 is a structural diagram of another VR control apparatus in accordance with an aspect of the disclosure. In one or more embodiments, the trajectory determination module 52 may include:

a direction determination module 521, configured to determine a moving direction in which the VR wearable device moves in the three-dimensional space based on sensor data within the set time period; and

a trajectory rendering sub-module 522, configured to render the moving trajectory of the VR wearable device on the VR display device based on the sensor data within the set time period in the direction chronologically and along the direction determined by the direction determination module 521.

In one or more embodiments, the trajectory rendering sub-module 522 is configured to:

at the first time point, render a first set of sensor data in the sensor data within the set time period in a central region of the VR display device;

render the moving trajectory corresponding to the sensor data within the set time period chronologically along the direction;

at the second time point, render the last set of sensor data among the sensor data within the set time period in the central region of the VR display device, and the step of rendering the moving trajectory of the VR wearable device is completed.

In one or more embodiments, the operation control module 53 includes:

a target trajectory determination sub-module 531, configured to determine a target trajectory matching the shape of the moving trajectory from a plurality of reference trajectories corresponding to an operation instruction for controlling the VR execution device;

an operation instruction determination sub-module 532, configured to determine an operation instruction corresponding to the target trajectory determined by the target trajectory determination sub-module 531; and

an operation execution sub-module 533, configured to control the VR execution device to perform an operation corresponding to the operation instruction determined by the operation instruction determination sub-module 532.

In one or more embodiments, the device may further includes:

a prompt message generation module 54, configured to generate a message for prompting the user to move the VR wearable device once again, if it is determined that there isn't a target trajectory from the plurality of reference trajectories; and

a data clearance module 55, configured to clear the sensor data within the set time period, after the prompt message generation module 54 has generated the prompt message.

In one or more embodiments, the data acquisition module may include:

a first acquisition sub-module 511, configured to acquire the sensor data of the electronic device indicating a movement of the VR wearable device in the three-dimensional space from a first gyro sensor, when receiving the first control instruction from the handle bounded to the VR wearable device;

a first stop sub-module 512, configured to, upon receipt of the second control instruction from the handle, stop acquiring sensor data from the first gyro sensor, and completing the acquisition of the sensor data within the set period of time.

FIG. 7 is a structural diagram of a further VR control apparatus according to an aspect of the disclosure. As shown in FIG. 7, on the basis of the embodiment shown in FIG. 5, in one or more embodiments, the data acquisition module 51 may include:

a first instruction generation sub-module 513, configured to generate the first control instruction and determining the first time point at which the first control instruction is generated, when it is detected that a predetermined button on the VR wearable device is triggered;

a second acquisition sub-module 514, configured to acquire the sensor data indicative of the movement of the VR wearable device in three-dimensional space which is captured by the second gyroscope of the VR wearable device according to the first control instruction;

a second instruction generation sub-module 515, configured to generate the second control instruction when it is detected that the predetermined button is triggered again; and

a second stop sub-module 516, configured to stop acquiring the sensor data from the second gyro sensor according to the second control instruction generated by the second instruction generation sub-module 515, so as to complete the acquisition of the sensor data within the set time period.

With respect to the apparatus in the above embodiment, the specific mode in which each module performs the operation has been described in details in the embodiment relating to the method as discussed above, and therefore the description thereof will not be described in details here.

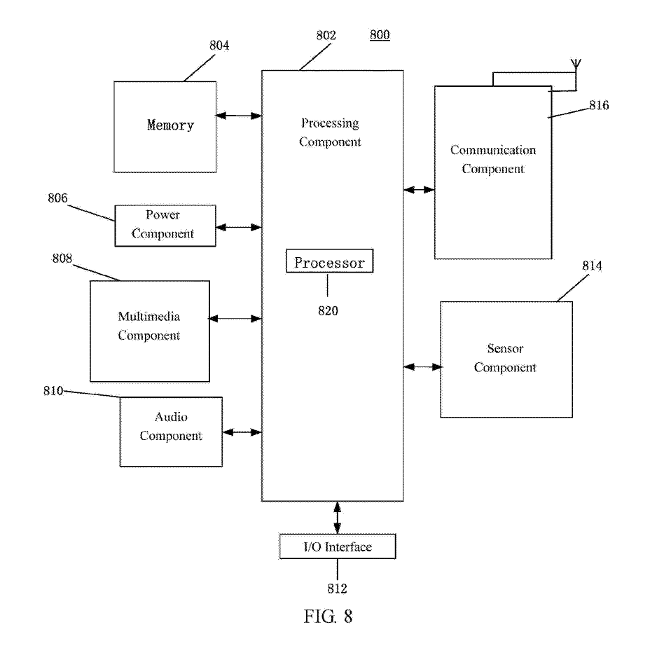

FIG. 8 is a block diagram of another device that is suitable for controlling a VR device according to an aspect of the disclosure. For example, the device 800 may be implemented with an electronic equipment, such as an intelligent device, a VR device (helmet), or the like.

Referring to FIG. 8, the device 800 may include one or more components: a processing component 802, memory 804, a power component 806, a multimedia component 808, an audio component 810, an input/output (I/O) interface 812, a sensor component 814, and a communication component 816.

The processing component 802 generally controls the overall operation of the device 800, such as, operations associated with display, phone call, data communication, camera operation, and recording operations. The processing unit 802 may include one or more processors 820 for executing instructions to complete all or part of the steps of the method described above. In addition, the processing component 802 may include one or more modules to facilitate the interaction between the processing component 802 and other components. For example, the processing component 802 may include a multimedia module, so as to facilitate the interaction between the multimedia component 808 and the processing component 802.

The memory 804 is configured to store various types of data to support operations of the device 800. Examples of such data include instructions, contact data, phonebook data, messages, pictures, videos, and the like for any application or method that operates on the device 800. The memory 804 may be implemented as any type of volatile or nonvolatile memory device or a combination thereof, such as, static random access memory (SRAM), electrically erasable programmable read only memory (EEPROM), erasable Programmable read only memory (EPROM), programmable read only memory (PROM), read only memory (ROM), magnetic memory, flash memory, disk or CD.

The power component 806 provides power for the various components of the device 800. The power component 806 may include a power management system, one or more power supplies, and other components associated with functions of generating, managing, and distributing power for the device 800. The power supplies may include a battery.

The multimedia component 808 includes a screen that provides an output interface between the device 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors for sensing touch, slide, and gestures on the touch panels. The touch sensor can sense not only the boundary of the touch or slide action but also the duration and pressure associated with the touch or slide operation. In some embodiments, the multimedia component 808 includes a front camera and/or a rear camera. The front camera and/or rear camera can receive external multimedia data when the device 800 is in an operating mode, such as, a shooting mode or a video mode. Each of the front camera and rear camera can be a fixed optical lens system or a zoom optical lens system.

The audio component 810 is configured to output and/or input an audio signal. For example, the audio component 810 includes a microphone (MIC) that is configured to receive an external audio signal when the device 800 is in an operating mode, such as a call mode, a recording mode, and a voice recognition mode. The received audio signal may be further stored in the memory 804 or transmitted via the communication component 816. In some embodiments, the audio component 810 may further include a loudspeaker for outputting audio signals.

The I/O interface 812 provides an interface between the processing component 802 and the peripheral interface module, wherein the peripheral interface module may be a keyboard, a click wheel, a button, or the like. These buttons may include, but are not limited to, a home button, a volume button, a start button, and a lock button.

The sensor component 814 includes one or more sensors for providing conditional assessments of various aspects of the device 800. For example, the sensor component 814 may detect the open/closed state of the device 800, the relative positioning of the components, for example, the component may be the display and keypad of the device 800. The sensor component 814 may also detect a change in the location of the device 800 or a component of the device 800, the presence or absence of the user's contact with the device 800, orientation or acceleration/deceleration of the device 800 and the temperature change of the device 800. The sensor component 814 may include a proximity sensor configured to detect the presence of a nearby object without any physical contact. The sensor component 814 may also include a light sensor, such as a CMOS or CCD image sensor, for use in imaging applications. In some embodiments, the sensor component 814 may also include an acceleration sensor, a gyro sensor, a magnetic sensor, a pressure sensor, or a temperature sensor.

The communication component 816 is configured to facilitate wired or wireless communication between the device 800 and other devices. The device 800 may access a wireless network based on a communication standard, such as WiFi, 2G or 3G, or a combination thereof. In an aspect of the disclosure, the communication component 816 receives a broadcast signal or broadcast-related information from an external broadcast management system via a broadcast channel. In an aspect of the disclosure, the communication component 816 may also include a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other techniques.

In an aspect of the disclosure, the device 800 may be implemented with one or more hardware devices, which include application specific integrated circuits (ASICs), digital signal processors (DSPs), digital signal processing devices (DSPDs), programmable logic devices (PLDs), field programmable A gate array (FPGA), a controller, a microcontroller, a microprocessor, or other electronic component, for performing the VR control method described above The device 800 may use the hardware devices in combination with the other hardware or software components for executing the method above.

Each module, sub-module, unit, or sub-unit disclosed above may be implemented at least partially using the one or more circuitries.

In an exemplary embodiment, there is also provided a non-temporary computer readable storage medium comprising instructions, such as a memory 804 that includes instructions, which may be executed by the processor 820 of the device 800 to perform the method described above. For example, non-temporary computer-readable storage media may be selected from ROM, random access memory (RAM), CD-ROM, magnetic tape, floppy disk, optical data storage device, and the like. The processor 820 is configured to:

acquiring sensor data indicative of a movement of a VR wearable device in three-dimensional space within a set time period, and the set time period is determined by a first time point at which a first control instruction is received and a second time point at which a second control instruction is received; determining a moving trajectory of the VR wearable device within the set time period based on the sensor data within the set time period; and controlling a VR execution device to perform one or more operations corresponding to the moving trajectory and to display operation effects corresponding to the moving trajectory on the VR display device.

The terminology used in the present disclosure is for the purpose of describing exemplary embodiments only and is not intended to limit the present disclosure. As used in the present disclosure and the appended claims, the singular forms “a,” “an” and “the” are intended to include the plural forms as well, unless the context clearly indicates otherwise. It shall also be understood that the terms “or” and “and/or” used herein are intended to signify and include any or all possible combinations of one or more of the associated listed items, unless the context clearly indicates otherwise.

It shall be understood that, although the terms “first,” “second,” “third,” etc. may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

Reference throughout this specification to “one embodiment,” “an embodiment,” “exemplary embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in an exemplary embodiment,” or the like in the singular or plural in various places throughout this specification are not necessarily all referring to the same embodiment. Furthermore, the particular features, structures, or characteristics in one or more embodiments may be combined in any suitable manner.

Other embodiments of the present disclosure will be readily apparent to those skilled in the art upon consideration of the specification and practice of the disclosure disclosed herein. The present application is intended to cover any variations, uses, or adaptations of the present disclosure that follow the general principles of the present disclosure and include common knowledge or conventional technical means in the art without departing from the present disclosure The specification and examples are to be regarded as illustrative only, and the protective scope of the disclosure are defined by the following claims.

It is to be understood that this disclosure is not limited to the precise constructions described above and shown in the drawings, and that various modifications and changes may be made without departing from the scope thereof. The scope of the present disclosure is only defined by the appended claims.

What is claimed is:

1. A virtual reality (VR) control method comprising:
determining a set time period defined by a first time point and a second time point, the first time point is set when receiving a first control instruction and the second time point is set when receiving a second control instruction;
acquiring sensor data indicative of a movement of a VR wearable device in three-dimensional space within the set time period;
determining a moving trajectory of the VR wearable device within the set time period based on the sensor data within the set time period; and
controlling a VR execution device to perform one or more operations corresponding to the moving trajectory and to display operation effects corresponding to the moving trajectory on the VR display device.

2. The method according to claim 1, wherein determining the moving trajectory of the VR wearable device within the set time period based on the sensor data within the set time period comprises:
determining a moving direction in which the VR wearable device moves in the three-dimensional space based on sensor data within the set time period; and
rendering the moving trajectory of the VR wearable device on the VR display device based on the sensor data within the set time period along the direction chronologically.

3. The method according to claim 2, wherein rendering the moving trajectory of the VR wearable device on the VR display device based on the sensor data within the set time period in the direction chronologically comprises:
at the first time point, rendering a first set of sensor data among the sensor data within the set time period in a central region of the VR display device;
rendering the moving trajectory corresponding to the sensor data within the set time period chronologically along the direction; and
at the second time point, rendering the last set of sensor data among the sensor data within the set time period in the central region of the VR display device, and said rendering the moving trajectory of the VR wearable device is completed.

4. The method according to claim 1, wherein controlling the VR execution device to perform one or more operations corresponding to the moving trajectory includes:
determining whether there is a target trajectory matching the shape of the moving trajectory from a plurality of reference trajectories corresponding to an operation instruction for controlling the VR execution device;
determining an operation instruction corresponding to the target trajectory; and
controlling the VR execution device to perform the operation corresponding to the operation instruction.

5. The method according to claim 4, further comprising:
generating a message for prompting to move the VR wearable device once again when determining that there isn't a target trajectory from the plurality of reference trajectories; and
clearing the sensor data within the set time period.

6. The method according to claim 1, wherein acquiring sensor data indicative of the movement of the VR wearable device in three-dimensional space within the set time period comprises:
upon receipt of the first control instruction from the handle bounded to the VR wearable device, acquiring the sensor data indicative of the movement of the VR wearable device in the three-dimensional space from a first gyro sensor of the electronic device; and
upon receipt of the second control instruction from the handle, stopping acquiring sensor data from the first gyro sensor, and completing acquisition of the sensor data within the set period of time.

7. The method according to claim 1, wherein acquiring sensor data indicative of a movement of the VR wearable device in three-dimensional space within the set time period comprises:
generating the first control instruction and determining the first time point at which the first control instruction is generated, when detecting that a predetermined button on the VR wearable device is triggered;
acquiring the sensor data indicative of the movement of the VR wearable device in three-dimensional space from the second gyroscope of the VR wearable device according to the first control instruction;
generating the second control instruction and determining the second time point at which the second control instruction is generated, when detecting that the predetermined button is triggered again; and
according to the second control instruction, stopping acquiring the sensor data from the second gyro sensor, and the acquisition of the sensor data within the set time period is completed.

8. A virtual reality (VR) control apparatus comprising:
a data acquisition circuitry configured to acquire sensor data indicative of a movement of a VR wearable device in three-dimensional space within a set time period, and the set time period is determined by a first time point at which a first control instruction is received and a second time point at which a second control instruction is received;
a trajectory determination circuitry configured to determine a moving trajectory of the VR wearable device within the set time period based on the sensor data within the set time period; and
an operation control circuitry configured to control a VR execution device to perform an operation corresponding to the moving trajectory and to display operation effects corresponding to the moving trajectory on the VR display device.

9. The device according to claim 8, wherein said trajectory determination circuitry comprises:
a direction determination circuitry configured to determine a moving direction in which the VR wearable device moves in the three-dimensional space based on sensor data within the set time period; and
a trajectory rendering sub-circuitry configured to render the moving trajectory of the VR wearable device on the VR display device based on the sensor data within the set time period in the direction chronologically.

10. The device according to claim 9, wherein said trajectory rendering sub-circuitry is configured to:
at the first time point, render a first set of sensor data among the sensor data within the set time period in a central region of the VR display device;
render the moving trajectory corresponding to the sensor data within the set time period chronologically along the direction;
at the second time point, render the last set of sensor data among the sensor data within the set time period in the central region of the VR display device, and said rendering the moving trajectory of the VR wearable device is completed.

11. The device according to claim 8, wherein said operation control circuitry comprises:
a target trajectory determination sub-circuitry configured to determine a target trajectory matching the shape of the moving trajectory from a plurality of reference trajectories, each of the plurality of reference trajectories corresponding to an operation instruction for controlling the VR execution device;
an operation instruction determination sub-circuitry configured to determine the operation instruction corresponding to the target trajectory; and
an operation execution sub-circuitry configured to control the VR execution device to perform an operation corresponding to the operation instruction.

12. The device according to claim 11, further comprising:
a prompt message generation circuitry configured to generate a message for prompting to move the VR wearable device once again if it is determined that there isn't a target trajectory from the plurality of reference trajectories; and
a data clearance circuitry configured to clear the sensor data within the set time period after the prompt message generation circuitry generates the message.

13. The device according to claim 8, wherein said data acquisition circuitry comprises:
a first acquisition sub-circuitry configured to acquire the sensor data indicative of a movement of the VR wearable device in the three-dimensional space from a first gyro sensor of the electronic device, upon receipt of the first control instruction from the handle bounded to the VR wearable device;
a first stop sub-circuitry configured to, upon receipt of the second control instruction from the handle, stop acquiring sensor data from the first gyro sensor, and completing acquisition of the sensor data within the set period of time.

14. The device according to claim 8, wherein said data acquisition circuitry comprises:
a first instruction generation sub-circuitry configured to generate the first control instruction and determining the first time point at which the first control instruction is generated, when it is detected that a predetermined button on the VR wearable device is triggered;
a second acquisition sub-circuitry configured to acquire the sensor data indicative of the movement of the VR wearable device in three-dimensional space from the second gyroscope of the VR wearable device according to the first control instruction;
a second instruction generation sub-circuitry configured to generate the second control instruction and determining the second time point at which the second control instruction is generated, when it is detected that the predetermined button is triggered again; and
a second stop sub-circuitry configured to stop acquiring the sensor data from the second gyro sensor according to the second control instruction, and the acquisition of the sensor data within the set time period is completed.

15. An electronic equipment comprising:
a processor, and
a memory configured to store instructions executable by the processor,
wherein the processor is configured to:
acquire sensor data indicative of a movement of a virtual reality (VR) wearable device in three-dimensional space within a set time period, where the set time period is determined by a first time point at which a first control instruction is received and a second time point at which a second control instruction is received;
determine a moving trajectory of the VR wearable device within the set time period based on the sensor data within the set time period; and
control a VR execution device to perform an operation corresponding to the moving trajectory and to display operation effects corresponding to the moving trajectory on the VR display device.

16. The electronic equipment according to claim 15, wherein the processor is further configured to:
determine a moving direction in which the VR wearable device moves in the three-dimensional space based on sensor data within the set time period; and
render the moving trajectory of the VR wearable device on the VR display device based on the sensor data within the set time period along the direction chronologically.

17. The electronic equipment according to claim 16, wherein the processor is further configured to:
at the first time point, render a first set of sensor data among the sensor data within the set time period in a central region of the VR display device;
render the moving trajectory corresponding to the sensor data within the set time period chronologically along the direction; and
at the second time point, render the last set of sensor data among the sensor data within the set time period in the central region of the VR display device, and said rendering the moving trajectory of the VR wearable device is completed.

18. The electronic equipment according to claim 15, wherein the processor is further configured to:
determine whether there is a target trajectory matching the shape of the moving trajectory from a plurality of reference trajectories corresponding to an operation instruction for controlling the VR execution device;
determine an operation instruction corresponding to the target trajectory; and
control the VR execution device to perform the operation corresponding to the operation instruction.

19. The electronic equipment according to claim 18, wherein the processor is further configured to:
generate a message for prompting to move the VR wearable device once again when determining that there isn't a target trajectory from the plurality of reference trajectories; and
clear the sensor data within the set time period.

20. The electronic equipment according to claim 15, wherein the processor is further configured to:
upon receipt of the first control instruction from the handle bounded to the VR wearable device, acquire the sensor data indicative of the movement of the VR wearable device in the three-dimensional space from a first gyro sensor of the electronic device; and
upon receipt of the second control instruction from the handle, stop acquiring sensor data from the first gyro sensor, and complete acquisition of the sensor data within the set period of time.
